(19) United States
(12) Patent Application Publication
(10) Pub. No.: US 2017/0366460 A1
(43) Pub. Date: Dec. 21, 2017

(54) RDMA-OVER-ETHERNET STORAGE SYSTEM WITH CONGESTION AVOIDANCE WITHOUT ETHERNET FLOW CONTROL

(71) Applicant: E8 Storage Systems Ltd., Ramat-Gan (IL)

(72) Inventors: Alex Friedman, Hadera (IL); Alex Liakhovetsky, Ra'nana (IL)

(21) Appl. No.: 15/492,000

(22) Filed: Apr. 20, 2017

Related U.S. Application Data
(60) Provisional application No. 62/351,974, filed on Jun. 19, 2016.

(51) Int. Cl. H04L 12/801; H04L 12/925; G06F 15/173; H04L 12/721; H04L 29/08; H04L 12/911

(52) U.S. Cl. CPC H04L 47/12; H04L 67/1097; H04L 47/823; G06F 15/17331; H04L 45/66; H04L 47/722

(57) ABSTRACT

An apparatus for data storage management includes one or more processors, and an interface for connecting to a communication network that connects one or more servers and one or more storage devices. The one or more processors are configured to receive a configuration of the communication network, including a definition of multiple network connections that are used by the servers to access the storage devices using a remote direct memory access protocol transported over a lossy layer-2 protocol, to calculate, based on the configuration, respective maximum bandwidths for allocation to the network connections, and to reduce a likelihood of congestion in the communication network, notwithstanding the lossy layer-2 protocol, by instructing the servers and the storage devices to comply with the maximum bandwidths.

### CROSS-REFERENCE TO RELATED APPLICATIONS

This application claims the benefit of U.S. Provisional Patent Application 62/351,974, filed Jun. 19, 2016, whose disclosure is incorporated herein by reference.

### FIELD OF THE INVENTION

The present invention relates generally to data storage, and particularly to methods and systems for avoiding network congestion in storage systems.

### BACKGROUND OF THE INVENTION

Various communication protocols are based on remote direct memory access. One such protocol is the Remote Direct Memory Access over Converged Ethernet (RoCE) protocol. A link-level version of RoCE, referred to as RoCE v1, is specified in “Supplement to InfiniBand Architecture Specification Volume 1 Release 1.2.1—Annex A16—RDMA over Converged Ethernet (RoCE),” InfiniBand Trade Association, Apr. 6, 2010, which is incorporated herein by reference. A routable version of RoCE, referred to as RoCE v2, is specified in “Supplement to InfiniBand Architecture Specification Volume 1 Release 1.2.1—Annex A17—RoCEv2,” InfiniBand Trade Association, Sep. 2, 2014, which is incorporated herein by reference. In the context of the present patent application, the term “a RoCE protocol” refers to both RoCE v1 and RoCE v2, as well as to variants or other versions of these protocols.

### SUMMARY OF THE INVENTION

An embodiment of the present invention that is described herein provides an apparatus for data storage management, including one or more processors, and an interface for connecting to a communication network that connects one or more servers and one or more storage devices. The one or more processors are configured to receive a configuration of the communication network, including a definition of multiple network connections that are used by the servers to access the storage devices using a remote direct memory access protocol transported over a lossy layer-2 protocol, to calculate, based on the configuration, respective maximum bandwidths for allocation to the network connections, and to reduce a likelihood of congestion in the communication network, notwithstanding the lossy layer-2 protocol, by instructing the servers and the storage devices to comply with the maximum bandwidths.

In an embodiment, the remote direct memory access protocol includes Remote Direct Memory Access over Converged Ethernet (RoCE). In an embodiment, the lossy layer-2 protocol includes Ethernet with disabled flow-control. In some embodiments, one or more of the network connections are used by the servers to communicate with a storage controller, for accessing the storage devices.

In an example embodiment, the configuration specifies a bandwidth of a physical link in the communication network, and the one or more processors are configured to calculate for a plurality of the network connections, which traverse the physical link, maximum bandwidths that together do not exceed the bandwidth of the physical link.

In some embodiments, the one or more processors are further configured to calculate respective maximum buffer-sizes for allocation to the network connections, and to instruct the servers and the storage devices to comply with the maximum buffer-sizes. In an example embodiment, the configuration specifies a size of an egress buffer of a port of a switch in the communication network, and the one or more processors are configured to calculate for a plurality of the network connections, which traverse the port, maximum buffer-sizes that together do not exceed the size of the egress buffer of the port. In another embodiment, the one or more processors are configured to calculate a maximum buffer-size for a network connection, by specifying a maximum burst size within a given time window.

In a disclosed embodiment, the one or more processors are configured to adapt one or more of the maximum bandwidths over time.

There is additionally provided, in accordance with an embodiment of the present invention, a method for data storage management including receiving a configuration of a communication network that connects one or more servers and one or more storage devices, including receiving a definition of multiple network connections that are used by the servers to access the storage devices using a remote direct memory access protocol transported over a lossy layer-2 protocol. Respective maximum bandwidths are calculated based on the configuration, for allocation to the network connections. A likelihood of congestion in the communication network is reduced, notwithstanding the lossy layer-2 protocol, by instructing the servers and the storage devices to comply with the maximum bandwidths.

There is further provided, in accordance with an embodiment of the present invention, a computer software product, the product including a tangible non-transitory computer-readable medium in which program instructions are stored, which instructions, when read by one or more processors in a communication network that connects one or more servers and one or more storage devices, cause the processors to: receive a configuration of the communication network, including a definition of multiple network connections that are used by the servers to access the storage devices using a remote direct memory access protocol transported over a lossy layer-2 protocol; based on the configuration, calculate respective maximum bandwidths for allocation to the network connections; and reduce a likelihood of congestion in the communication network, notwithstanding the lossy layer-2 protocol, by instructing the servers and the storage devices to comply with the maximum bandwidths.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system that uses distributed data storage, in accordance with an embodiment of the present invention; and

FIG. 2 is a flow chart that schematically illustrates a method for congestion avoidance in the system of FIG. 1, in accordance with an embodiment of the present invention.

### DETAILED DESCRIPTION OF EMBODIMENTS

### Overview

Embodiments of the present invention that are described herein provide improved methods and systems for data storage using remote direct memory access over communication networks. In some example embodiments, the disclosed techniques enable efficient deployment of RoCE in storage applications.

Conventionally, RoCE protocols require the underlying layer-2 protocol to be lossless. This requirement is detrimental to system performance in many practical scenarios, e.g., in case of actual or imminent congestion.

In Ethernet networks, for example, a lossless layer-2 is typically achieved by applying flow control, e.g., link-level flow control (LLFC) or priority flow control (PFC), in the various network switches and network interfaces. The flow control mechanism, however, pauses the traffic when congestion is imminent, thereby causing degraded performance such as head-of-line blocking and poor link utilization.

Another possible solution is to separate different traffic flows to different service classes using PFC. This sort of solution, however, limits the number of connected endpoints to the number of service classes. Yet another possible solution is to employ Early Congestion Notifications (ECN). This solution, however, requires the network switches to be configured for ECN marking. If some of the network traffic does not conform to ECN, it is necessary to segregate between ECN and non-ECN traffic, e.g., using different service classes, to avoid collapse of ECN traffic. When congestion is imminent, ECN schemes behave very similarly to schemes that pause the traffic, causing similar detrimental effects.

Embodiments of the present invention avoid the above-described performance issues and challenges, by enabling RoCE to operate reliably over a lossy layer-2 in the first place. In some disclosed embodiments, a computing system comprises one or more servers and one or more storage devices. The computing system may further comprise one or more storage controllers. The servers, storage devices and storage controllers are referred to collectively as endpoints.

The endpoints communicate with one another over a network, which typically comprises one or more network switches and multiple network links. The network is not assumed to be lossless. For example, the network may comprise a converged Ethernet network in which the various switches and network interfaces are configured to have flow control disabled.

In addition, the computing system runs a Congestion Management Service (CMS) that prevents congestion events in the network. The CMS receives the network configuration as input. The network configuration may comprise, for example, (i) the interconnection topology of the switches, links, servers and storage devices, (ii) the effective bandwidths of the links, (iii) the buffer-sizes of the egress buffers of the switches, and (iv) a list of network connections used by the endpoints to communicate with one another. The network configuration may also comprise Quality-of-Service (QoS) requirements such as guaranteed bandwidths of certain connections.

Based on the network configuration, the CMS allocates for each connection (i) a respective maximum bandwidth and (ii) a respective maximum buffer-size. The maximum bandwidths are allocated such that no link will exceed its effective bandwidth. The maximum buffer-sizes are allocated to limit the burstiness on the connections, such that no switch egress buffer will overflow. The CMS notifies the various servers and storage devices of the maximum bandwidths and buffer-sizes allocated to their connections. The servers and storage devices communicate over the connections using RoCE, while complying with the allocated maximum bandwidths and buffer-sizes.

The disclosed techniques limit the bandwidth and burstiness at the endpoint level, e.g., at the level of the server or storage device that generates the traffic in the first place. As a result, congestion in the network is prevented even when the switches and network interfaces do not apply any flow control means. Therefore, the performance degradation associated with flow control is avoided. In some embodiments, the CMS adapts the bandwidth allocations over time, to match the actual network traffic conditions.

### System Description

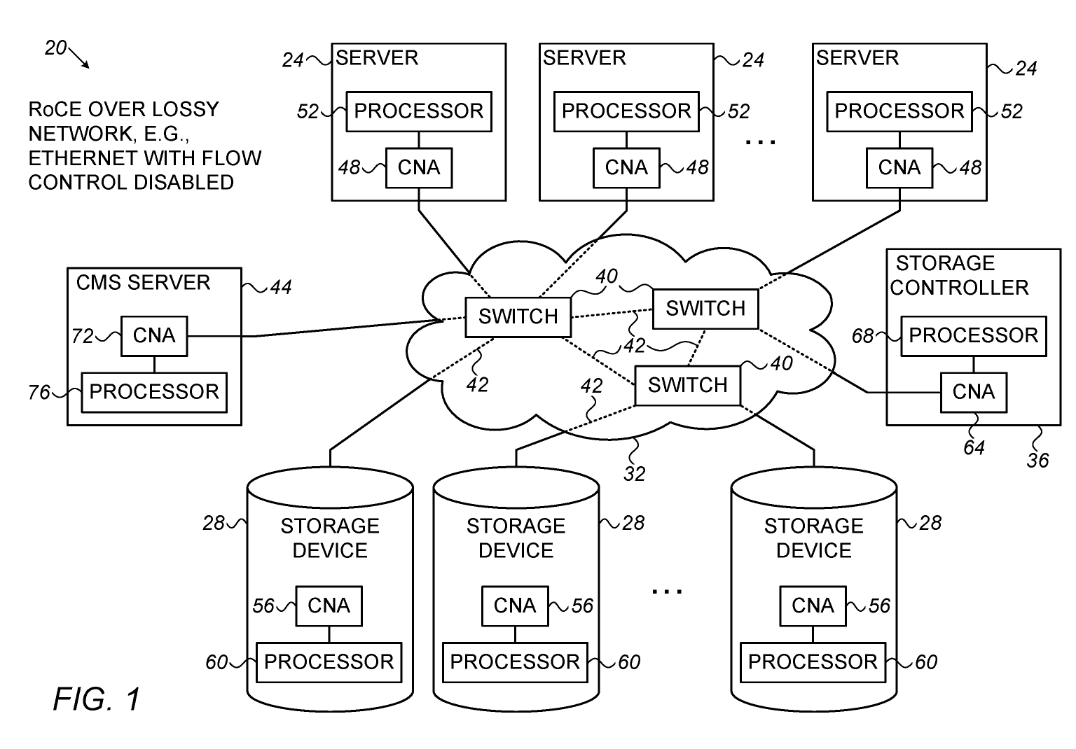

FIG. 1 is a block diagram that schematically illustrates a computing system 20 that uses distributed data storage, in accordance with an embodiment of the present invention. System 20 may comprise, for example, a data center, a High-Performance Computing (HPC) cluster, or any other suitable system.

System 20 comprises multiple servers 24 and multiple storage devices 28. The system further comprises one or more storage controllers 36 that manage the storage of data in storage devices 28. The servers, storage devices and storage controllers are interconnected by a communication network 32.

Servers 24 may comprise any suitable computing platforms that run any suitable applications. In the present context, the term “server” includes both physical servers and virtual servers. For example, a virtual server may be implemented using a Virtual Machine (VM) that is hosted in some physical computer. Thus, in some embodiments multiple virtual servers may run in a single physical computer. Storage controllers 36, too, may be physical or virtual. In an example embodiment, the storage controllers may be implemented as software modules that run on one or more physical servers 24.

Storage devices 28 may comprise any suitable storage medium, such as, for example, Solid State Drives (SSD), Non-Volatile Random Access Memory (NVRAM) devices or Hard Disk Drives (HDDs). In an example embodiment, storage devices 28 comprise multi-queued SSDs that operate in accordance with the NVMe specification. In such an embodiment, each storage device 28 provides multiple server-specific queues for storage commands. In other words, a given storage device 28 queues the storage commands received from each server 24 in a separate respective server-specific queue. The storage devices typically have the freedom to queue, schedule and reorder execution of storage commands. The terms “storage commands” and “I/Os” are used interchangeably herein.

Network 32 may operate in accordance with any suitable communication protocol, such as Ethernet or Infiniband. In the present example, network 32 comprises a converged Ethernet network. Network 32 comprises one or more packet switches 40 (also referred to as network switches, or simply switches for brevity) and multiple physical network links 42 (e.g., copper or fiber links, referred to simply as links for brevity). Links 42 connect the endpoints to switches 40, as well as switches 40 to one another.

In some embodiments, some or all of the communication among servers 24, storage devices 28 and storage controllers 36 is carried out using remote direct memory access operations. The embodiments described below refer mainly to RDMA over Converged Ethernet (RoCE) protocols, by way of example. Alternatively, however, any other variant of RDMA may be used for this purpose, e.g., Infiniband (IB), Virtual Interface Architecture or internet Wide Area RDMA Protocol (iWARP). Further alternatively, the disclosed techniques can be implemented using any other form of direct memory access over a network, e.g., Direct Memory Access (DMA), various Peripheral Component Interconnect Express (PCIe) schemes, or any other suitable protocol. In the context of the present patent application and in the claims, all such protocols are referred to as “remote direct memory access.” Any of the RDMA operations mentioned herein is performed without triggering or running code on any storage controller CPU.

Generally, system 20 may comprise any suitable number of servers, storage devices and storage controllers. Servers 24, storage devices 28 and storage controllers 36 are referred to collectively as “endpoints” (EPs) that communicate with one another over network 32. System 20 further comprises a Congestion Management Service (CMS) server 44 that is responsible for optimizing bandwidth allocation and basic routing for the various endpoints, while avoiding congestion. The operation of CMS 44 is described in detail below.

In the disclosed techniques, data-path operations such as writing and readout are performed directly between the servers and the storage devices, without having to trigger or run code on the storage controller CPUs. The storage controller CPUs are involved only in relatively rare control-path operations. Moreover, the servers do not need to, and typically do not, communicate with one another or otherwise coordinate storage operations with one another. Coordination is typically performed by the servers accessing shared data structures that reside, for example, in the memories of the storage controllers.

In the embodiments described herein, the assumption is that any server 24 is able to communicate with any storage device 28, but there is no need for the servers to communicate with one another. Storage controllers 36 are assumed to be able to communicate with all servers 24 and storage devices 28, as well as with one another.

Further aspects of such a system are addressed, for example, in U.S. Pat. Nos. 9,112,890, 9,274,720, 9,519,666, 9,521,201, 9,525,737 and 9,529,542, whose disclosures are incorporated herein by reference.

In the embodiment of FIG. 1, each endpoint comprises a network interface for connecting to network 32, and a processor that is configured to carry out the various tasks of that endpoint. In the present example, network 32 comprises a converged Ethernet network, in which case switches 40 comprise Ethernet switches, and the network interfaces are referred to as Converged Network Adapters (CNAs). In the example of FIG. 1, each server 24 comprises a CNA 48 and a processor 52, each storage device 28 comprises a CNA 56 and a processor 60, each storage controller comprises a CNA 64 and a processor 68, and CMS server 44 comprises a CNA 72 and a processor 76. Alternatively, depending on the network type and protocols used, the network interfaces may comprise Network Interface Controllers (NICs), Host Bus Adapters (HBAs), Host Channel Adapters (HCAs), or any other suitable network interface.

The configuration of system 20 shown in FIG. 1 is an example configuration, which is chosen purely for the sake of conceptual clarity. In alternative embodiments, any other suitable system configuration can be used. For example, the description that follows refers to the CMS functions as being carried out by a standalone server—CMS server 44. This configuration is, however, in no way mandatory. In alternative embodiments, the CMS functions can be carried out by any other (one or more) processors in system 20. For example, the CMS functions may be implemented as a distributed service running on one or more of processors 52 of servers 24, without any centralized entity. As another example, the CMS functions may be carried out by processor 68 of storage controller 36. In the description that follows, the various tasks of CMS server 44 are referred to as being carried out by processor 76. CMS server 44 is referred to simply as “CMS 44” or “CMS”, for clarity.

The different elements of system 20 may be implemented using suitable hardware, using software, or using a combination of hardware and software elements. In various embodiments, any of processors 52, 60, 68 and 76 may comprise a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Reliable RoCE Operation Over Lossy Layer-2 Network

Referring again to the example of FIG. 1, each switch 40 comprises multiple ports (referred to as “switch ports”) for connecting to links 42 that lead to other switches or to CNAs of endpoints. Each CNA comprises one or more ports (referred to as “endpoint ports”) for connecting to respective links 42 that lead to respective ports of a switch. The endpoints communicate with one another over respective network connections, referred to as “connections” for brevity.

Each connection begins at an endpoint port (e.g., a CNA port of a server), traverses one or more switches 40 and links 42, and ends at another endpoint port (e.g., a CNA port of a storage device). The endpoints carry out various storage I/O commands over the connections using RoCE.

Typically, each connection can sustain a certain traffic bandwidth (e.g., depending on the bandwidths of the links traversed by the connection), and a certain extent of burstiness (e.g., depending on the sizes of the egress buffers of the switches traversed by the connection). When multiple connections traverse the same link or switch, they may affect each other's maximum sustainable bandwidth and/or burstiness. Exceeding the maximum sustainable bandwidth and/or burstiness may cause congestion and lead to data loss.

In the embodiments described herein, CMS 40 enables the endpoints of system 20 to communicate reliably using RoCE, even though layer-2 of network 32 is not lossless. In some embodiments, CNAs 48, 56 and 64 and switches 40 communicate using Ethernet, but without Ethernet flow control (e.g., have the flow control feature disabled). CMS 40 avoids congestion by analyzing the network configuration of system 20 and, based on the network configuration, allocating a maximum bandwidth and a maximum buffer-size to each connection.

In some embodiments, when using the disclosed technique it is assumed that network 32 is used for a homogeneous traffic type (in the present example RoCE, for a specific application). Alternatively, it is assumed that some bandwidth of network 32 is allocated for such homogeneous traffic type, e.g., by a suitable Quality-of-Service (QoS) configuration of switches 40.

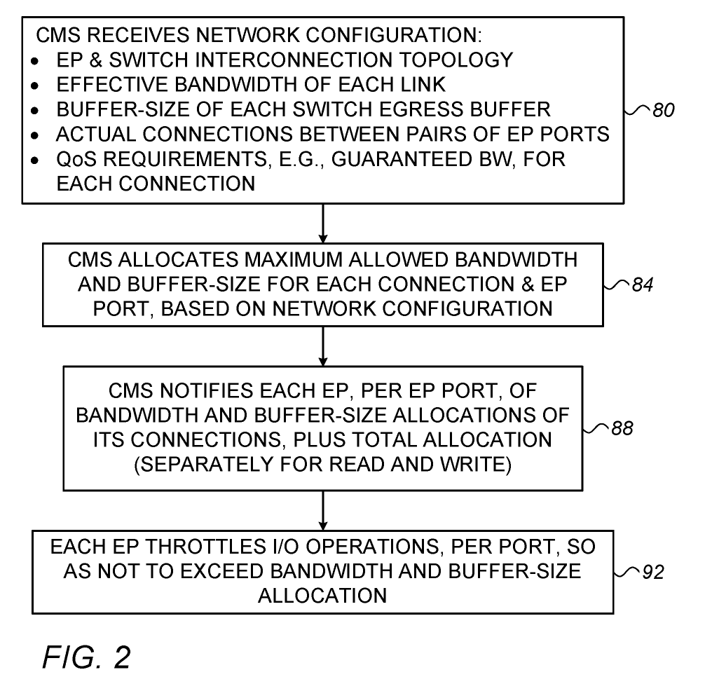

FIG. 2 is a flow chart that schematically illustrates a method for congestion avoidance in the system of FIG. 1, in accordance with an embodiment of the present invention. The method begins at a configuration input step 80, with CMS 40 receiving as input a network configuration that may comprise, for example:
The interconnection topology of switches 40, links 42, servers 24, storage devices 28 and storage controller(s) 36. The interconnection topology may comprise, for example, a list of all switches 40, a list of all endpoints, and a list of all links 42 that also specifies the two ports connected by each link.
The effective bandwidth of each link 42.
The buffer-size of each egress buffer of each switch 40.
A list of the network connections, each connection being defined between a pair of endpoint ports. The connections may comprise, for example, connections used by servers 24 to access storage devices 28, connections used by servers 24 to access data structures on controller 36, or any other suitable connections.
Optionally, a QoS requirement, such as guaranteed bandwidth, per connection (possibly for only some of the connections).

In some embodiments, CMS 40 obtains the available bandwidths and buffer sizes by performing advance measurements, per connection. Based on the network configuration, CMS 40 allocates a maximum bandwidth and a maximum buffer-size for each connection, at an allocation step 84. In an example embodiment, CMS 40 represents the allocations as a list of Congestion Avoidance Entries (CAEs), each CAE defining a maximum bandwidth limit (e.g., in bytes-per-second) and a maximum buffer-size (a maximum burst size, e.g., in bytes).

At a notification step 88, the CMS provides each endpoint port with the following allocation that should not be exceeded:
“W_CAE_ARRAY”—An array of CAEs for write operations (e.g., RDMA write, send, etc.), one CAE per destination endpoint port. The CAEs in W_CAE_ARRAY are indexed by the identifiers (id) of the destination endpoint ports.
“R_CAE_ARRAY”—An array of CAEs for read operations (e.g., RDMA read), one CAE per destination endpoint port. The CAEs in R_CAE_ARRAY are also indexed by destination endpoint port id.
“TOTAL_W_CAE”—A CAE that limits the total write bandwidth and buffer-size of the endpoint port.
“TOTAL_R_CAE”—A CAE that limits the total read bandwidth and buffer-size of the endpoint port.

CMS 40 typically calculates the various CAEs by determining which switches 40 (and thus which egress buffers) and which links 42 are traversed by each connection, and dividing the link bandwidths and buffer sizes among the connections.

In an embodiment, a CAE having a maximum bandwidth of zero means that no limit is imposed on the bandwidth. In an embodiment, the maximum buffer-size specified in a CAE is based on the minimal egress buffer size found along the connection. In many practical cases, the minimal egress buffer size is found in the egress buffer of the switch port connected to the endpoint port of the destination endpoint. If QoS is enabled, the maximum buffer size specified in a CAE is typically based on the portion of the egress buffer allocated to the traffic in question.

When dividing the bandwidth of a certain link, or the buffer-size of a certain egress buffer, among multiple connections, the CMS need not necessarily divide the resources uniformly. The division may consider, for example, differences in QoS requirements (e.g., guaranteed bandwidth) from one connection to another, as well as other factors.

Typically, when performing bandwidth allocation, the CMS takes into consideration various kinds of traffic overhead that may be introduced by lower layers. Such overhead may comprise, for example, overhead due to fragmentation of packets or addition of headers.

At an endpoint throttling step 92, each endpoint limits its RoCE operations (e.g., RDMA write, read and send), per port, so as not to exceed the maximum bandwidth and buffer-size allocated to that port. Consider a given CAE that specifies the maximum bandwidth and maximum buffer-size for a given connection. In an embodiment, the endpoint defines a Time Window (TW) size equal to the maximum buffer-size divided by the maximum bandwidth. Since a specific traffic burst may begin during one TW and continue in the next TW, the endpoint limits the amount of traffic per time window TW to half the maximum buffer-size. In alternative embodiments, the endpoints may throttle their I/O traffic, based on the CAEs, in any other suitable way.

In one example embodiment, CMS 44 calculates the maximum bandwidth and buffer-size allocations for the various connections by creating, for each connection, a Directed Acyclic Graph (DAG) whose vertices represent ports (switch ports or endpoint ports) and whose arcs represent network links 42. A given DAG, representing a requested connection between two endpoints, comprises the various paths via the network that can be chosen for the connection. Using the DAGs, the CMS allocates the maximum bandwidths and buffer-sizes such that:
The sum of the maximal bandwidth allocated to the connections traversing a given link does not exceed the effective bandwidth of that link.

The sum of the maximal buffer-sizes allocated to the connections traversing a given switch port does not exceed the egress buffer size of that switch port.

### Adaptive Bandwidth and Buffer-Size Allocation

In some embodiments, CMS 44 is pre-configured with a static routing plan and bandwidth allocation table. In these embodiment, the bandwidth allocations produced by the CMS are fixed. In other embodiments, CMS 44 may adapt the bandwidth and/or buffer-size allocations (e.g., CAEs) over time to match the actual network conditions. For example, the CMS may measure (or receive measurements of) the actual throughput over one or more of links 42, the actual queue depth at one or more of the endpoints, or any other suitable metric. The CMS may change one or more of the CAEs based on these measurements.

In an example embodiment, each endpoint (e.g., each server, storage device and/or storage controller) measures the actual amount of data that is queued and waiting for read and/or write operations. The endpoints typically measure the amount of queued data separately for read and for write, per connection. The endpoints send to CMS 44 reports that are indicative of the measurements, e.g., periodically.

Based on the measurements reported by the endpoints, CMS 44 may decide to adapt one or more of the maximum bandwidth or maximum buffer-size allocations, so as to rebalance the allocation and better match the actual traffic needs of the endpoints. For example, the CMS may increase the maximum bandwidth or maximum buffer-size allocation for an endpoint having a large amount of queued data, at the expense of another endpoint that has less queued data. The rebalancing operation can also be influenced by QoS requirements, e.g., guaranteed bandwidth.

Although the embodiments described herein mainly address RDMA protocols such as RoCE, the methods and systems described herein are also applicable to other protocols that conventionally require underlying flow-control. Such protocols may comprise, for example, Fibre-Channel over Ethernet (FCoE), Internet Small Computer Systems Interface (iSCSI), iSCSI Extensions for RDMA (iSER), or NVM Express (NVMe) over Fabrics.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An apparatus for data storage management, comprising:
an interface for connecting to a communication network that connects one or more servers and one or more storage devices; and
one or more processors, configured to:
receive a configuration of the communication network, including (i) a definition of multiple network connections that are used by the servers to access the storage devices using a remote direct memory access protocol transported over a lossy layer-2 protocol and (ii) bandwidths of physical links of the communication network;
based on the definition of the network connections and on the bandwidths of the physical links, calculate maximum bandwidths for allocation to the respective network connections; and
reduce a likelihood of congestion in the communication network, notwithstanding the lossy layer-2 protocol, by notifying the servers and the storage devices of the maximum bandwidths allocated to the network connections, and instructing the servers and the storage devices to throttle traffic of the remote direct memory access protocol, so as not to exceed the maximum bandwidths.

2. The apparatus according to claim 1, wherein the remote direct memory access protocol comprises Remote Direct Memory Access over Converged Ethernet (RoCE).

3. The apparatus according to claim 1, wherein the lossy layer-2 protocol comprises Ethernet with disabled flow-control.

4. The apparatus according to claim 1, wherein one or more of the network connections are used by the servers to communicate with a storage controller, for accessing the storage devices.

5. The apparatus according to claim 1, wherein the configuration specifies a bandwidth of a physical link in the communication network, and wherein the one or more processors are configured to calculate for a plurality of the network connections, which traverse the physical link, maximum bandwidths that together do not exceed the bandwidth of the physical link.

6. The apparatus according to claim 1, wherein the one or more processors are further configured to calculate respective maximum buffer-sizes for allocation to the network connections, and to instruct the servers and the storage devices to comply with the maximum buffer-sizes.

7. The apparatus according to claim 6, wherein the configuration specifies a size of an egress buffer of a port of a switch in the communication network, and wherein the one or more processors are configured to calculate for a plurality of the network connections, which traverse the port, maximum buffer-sizes that together do not exceed the size of the egress buffer of the port.

8. The apparatus according to claim 6, wherein the one or more processors are configured to calculate a maximum buffer-size for a network connection, by specifying a maximum burst size within a given time window.

9. The apparatus according to claim 1, wherein the one or more processors are configured to adapt one or more of the maximum bandwidths over time.

10. A method for data storage management, comprising:
receiving a configuration of a communication network that connects one or more servers and one or more storage devices, including receiving (i) a definition of multiple network connections that are used by the servers to access the storage devices using a remote direct memory access protocol transported over a lossy layer-2 protocol and (ii) bandwidths of physical links of the communication network;
based on the definition of the network connections and on the bandwidths of the physical links, calculating maximum bandwidths for allocation to the respective network connections; and
reducing a likelihood of congestion in the communication network, notwithstanding the lossy layer-2 protocol, by notifying the servers and the storage devices of the maximum bandwidths allocated to the network connections, and instructing the servers and the storage devices to throttle traffic of the remote direct memory access protocol, so as not to exceed the maximum bandwidths.

11. The method according to claim 10, wherein the remote direct memory access protocol comprises Remote Direct Memory Access over Converged Ethernet (RoCE).

12. The method according to claim 10, wherein the lossy layer-2 protocol comprises Ethernet with disabled flow-control.

13. The method according to claim 10, wherein one or more of the network connections are used by the servers to communicate with a storage controller, for accessing the storage devices.

14. The method according to claim 10, wherein the configuration specifies a bandwidth of a physical link in the communication network, and wherein calculating the maximum bandwidths comprises calculating for a plurality of the network connections, which traverse the physical link, maximum bandwidths that together do not exceed the bandwidth of the physical link.

15. The method according to claim 10, and further comprising calculating respective maximum buffer-sizes for allocation to the network connections, and instructing the servers and the storage devices to comply with the maximum buffer-sizes.

16. The method according to claim 15, wherein the configuration specifies a size of an egress buffer of a port of a switch in the communication network, and wherein calculating the maximum buffer-sizes comprises calculating for a plurality of the network connections, which traverse the port, maximum buffer-sizes that together do not exceed the size of the egress buffer of the port.

17. The method according to claim 15, wherein calculating the maximum buffer-sizes comprises calculating a maximum buffer-size for a network connection, by specifying a maximum burst size within a given time window.

18. The method according to claim 10, and comprising adapting one or more of the maximum bandwidths over time.

19. A computer software product, the product comprising a tangible non-transitory computer-readable medium in which program instructions are stored, which instructions, when read by one or more processors in a communication network that connects one or more servers and one or more storage devices, cause the processors to:
receive a configuration of the communication network, including (i) a definition of multiple network connections that are used by the servers to access the storage devices using a remote direct memory access protocol transported over a lossy layer-2 protocol and (ii) bandwidths of physical links of the communication network;
based on the definition of the network connections and on the bandwidths of the physical links, calculate maximum bandwidths for allocation to the respective network connections; and
reduce a likelihood of congestion in the communication network, notwithstanding the lossy layer-2 protocol, by notifying the servers and the storage devices of the maximum bandwidths allocated to the network connections, and instructing the servers and the storage devices to throttle traffic of the remote direct memory access protocol, so as not to exceed the maximum bandwidths.
